(19) United States
(12) Patent Application Publication
(10) Pub. No.: US 2021/0402459 A1
(43) Pub. Date: Dec. 30, 2021

(54) PRODUCTION SYSTEM FOR MACHINING WORPIECES

(71) Applicant: AIDA EUROPE GMBH, Weingarten (DE)

(72) Inventors: Thomas SPIESSHOFER, Bermatingen (DE); Anton LENDLER, Weingarten (DE); Christian MUELLER, Mengen (DE); Anett PFOHL, Ravensburg (DE)

(21) Appl. No.: 17/290,790

(22) PCT Filed: Dec. 4, 2018
(86) PCT No.: PCT/IB2018/001382

§ 371 Date: May 3, 2021

(51) Int. Cl. B21D 43/05; B21D 43/20; B30B 15/30; B64C 39/02

(52) U.S. Cl. CPC B21D 43/05; B21D 43/20; B64C 2201/127; B64C 39/024; B30B 15/30

(57) ABSTRACT

Production system for machining workpieces including a transfer comprising receiving and passing on the workpieces for machining from process Station to process Station in a chamber, such as a pressing unit. In the production system, logistical and technological processes are improved by implementing unmanned aerial vehicles (UAV). The UAV is used for process Support monitoring the production process of one of the workpieces or the transfer of the workpieces.

### TECHNICAL AREA

The invention relates to a production system for machining workpieces, in particular for the forming machining of workpieces using presses, preferably in a press plant, where the workpieces, such as prefabricated blanks, are machined or formed into a semi-finished or finished component by means of individual presses, transfer presses and/or press lines.

### STATE OF THE ART

In an industrial press plant representing a complex production system for machining workpieces with technological linking, which includes
a system for sheet metal strips to be unwound from coils, from which workpieces are guided flat to a cutting press and cut out as so-called blanks, and
a stacking/loading device such as a blank loader, with which the blanks are conveyed for further forming machining, and
the aforementioned press types with which the forming machining such as cutting, embossing, punching or three-dimensional forming (deep drawing) of the blanks into pressed parts is carried out,
   the transfer of the blanks to the semi-finished or finished component, which is typical for each type of press, plays a key role throughout. This is characterized by a complex logistical and constructive-technological effort, which is different for each type of press.

For example, transfer presses are designed with a large column passage, the largest possible tool surface, multi-point drive and, depending on the requirements, as single or multi-plunger machines. Belt systems, blank loaders and complex multi-axis transfer systems are used to convey material.

Press lines for forming workpieces such as blanks resulting in a component can include up to six individual presses. Complex transfer devices or robots are used for transferring the workpieces from the press-to-press/process-stage to process-stage depending on the requirements.

In addition to robots, gantry systems such as feeders or transfer systems, which bridge the space between the presses or process stages and remove the workpiece from the previous tool operation and insert it into the next, are used to transfer the workpiece to be machined between the individual presses.

For example, a feeder is a loading system that can usually be moved along two main axes. The X and Z axes, which are used for loading, cover a horizontal as well as a vertical transfer path for picking up workpieces—mostly from above—and placing them back on another level. The feeder picks up blanks with a gripper spider equipped with suction cups, magnets or other suitable equipment as well as a lifting system, places them in the press or transports them from one press to another.

A transfer can similarly also be manipulated by robots, regardless of the employed attachment types or systems.

The complex system for the forming machining of workpieces with presses includes both the logistical and technological processes and the press types as well as transfer facilities that are expensive and take up installation space.

A person skilled in the art recognizes today that each transfer of workpieces requires a structural effort for a relatively large installation space for presses, transfer presses and/or press lines, which would not be necessary in view of the machine-specific design/layout of a press.

In the areas of a press plant, such as delivery (e.g. of the coils of metal strips), cutting (e.g. splitting the strip and cutting of the blanks) and pressing, the technological process in the area of the presses, i.e. the entirety of the forming process steps, is particularly significant for economic production of the components to be formed.

When setting up press lines with, for example, large capacity presses or high-speed servo presses, the operators of the press plants increasingly emphasize and demand shortening the transfer process in terms of technological times and reducing the outlay for fixtures/equipment, thereby to increasing the output of workpieces and rationalizing the tool/tooling change.

This creates the problem of solving the forwarding of a workpiece to be machined by means of feeders, transfer devices or robots that are currently complex in terms of equipment and costs as well as large installation spaces for the transfer by using new systems, especially since increased technological requirements are placed on the actual production of the workpieces.

For example, DE 10 2016 124 798 A1 discloses employing in production systems for machining workpieces at least one drone for transferring the workpiece between the manufacturing process stations. At least one of the manufacturing process stations is hereby arranged on a first level and are the remaining manufacturing process stations are arranged on a second level. The drone transfers the workpiece across a space with an open ceiling between the first level and the second level.

A server, which transmits a command to the drone via wireless communication, is provided in the production system for intensive management of a flight path of the drone.

According to DE 10 2015 008 151 A1, a guide-beam-controlled drone navigation could be used for similar processes with appropriate adaptation, wherein the drone moves along the guide beam emitted by a suitable emitter and uses it for navigation.

AT 15021 U1 discloses a method and system for picking products in intralogistics, in which products of a picking assignment are placed by airworthy objects into at least one order container assigned to the picking order.

According to DE 10 2016 206 982 A1, unmanned aerial vehicles such as a helicopter drone for inspecting technical objects that are difficult to access already have a 3D scanner mounted on a rotatable joint, which includes a high-resolution camera for taking a large number of images from different shooting positions and shooting directions. A position and an orientation of the 3D scanner relative to the object can be determined by comparing images. A corresponding coordination device for controlling the 3D scanner, the rotatable joint and the helicopter drone generates a data representation of a surface profile of the object using the recorded images for the purpose of damage analysis via an image machining module.

Accordingly, it is known in production systems to pick up workpieces, such as products, with airborne objects, such as drones, controlled by control systems for purely logistical processes at a delivery point and to deliver them after a flight phase within a building, for example, to the order container in a commissioned manner. In the meantime, the product is not subject to any changeable or active technological process steps, such as cutting or non-cutting machining.

The professional review and evaluation of the relevant prior art shows that unmanned aerial vehicles/objects, such as drones
increasingly have highly complex equipment consisting of mechanical and electronic means as well as data machining, and
can take over functions for purely logistical processes in production systems,
   while only streamlining logistical processes.

In complex production systems,
the required process monitoring of technological processes, process stages and work steps, as well as
the requirements of the transfer of workpieces which change from process stage to process stage due to, for example, different attachment types for receiving and depositing the workpieces
   have so far not been taken into account or cannot be solved with the purely logistical use of unmanned aerial objects.

Improvements are therefore needed because the problem, in particular in a press plant, associated with process monitoring and forwarding, i.e. the so-called transfer of a workpiece to be machined by means of transfer devices which are currently complex and expensive, such as feeders or robots as well as large installation spaces for the transfer, will have to be solved with new systems in the future.

This requires special considerations in order to be able to employ unmanned aerial vehicles for
the complex processes and technological machining steps of workpieces, and
the time- and position-dependent and kinematic transfers and attachment functions,
   with the expectation to enable further construction-optimizing press designs in the future, especially in the context of a space-optimized press plant.

### DESCRIPTION OF THE INVENTION

It is an object of the invention to provide a complex production system for machining workpieces for technological process monitoring of operations and a safe transfer with attachment functions for workpieces, in order to enable and improve the process flow of workpieces to be machined up to the semi-finished or finished component during machining by means of presses, transfer presses or press lines, in particular in a press plant, to a large extent by
reducing technological machining times and time specifications for maintenance and servicing,
multiple passage or conveying of semi-finished components, linking of machines,
reducing the complexity and installation space previously due to conventional feeders, transfer devices or robots,
process-reliable and faster processes without stationary transfer means,
diverting workpieces to other work processes and reinsertion, execution of unpredictable or necessary technological or logistical operations, which can also be carried out without changing tools,
   namely by using unmanned aerial vehicles (UAV), hereinafter referred to as UAV.

According to the invention, this problem can in principle be solved with a production system for workpieces to be machined, in particular for machining workpieces by means of presses, transfer presses or press lines, with a transfer encompassing the pick-up and forwarding of the workpieces for technological machining from process station to process station in a space, preferably in a press plant, wherein at least one UAV is used for process support that monitors at least the production sequence of one of the workpieces or at least includes the transfer of at least one of the workpieces.

This makes it possible to streamline the aforementioned
complex processes and technological machining steps of workpieces and/or
the time- and position-dependent, kinematic transfers and attachment functions of the workpieces,
   so that further design-optimizing press designs, in particular in the context of a space-optimized press plant. can be realized.

For this purpose, the UAV has lift means, of which after the workpieces have been picked up, depending on the transfer or the workpiece
a lift means that does not affect the lift can be switched off, and
at least one lift means that affects the lift can be used for process support of the UAV relating to monitoring or at least the transfer of at least one of the workpieces.

The principle of the invention is designed in two variants, which can be used in combination to provide a synergistic effect.

On the one hand, the UAV for process monitoring of the production system should have at least one or one of the following features or functions:
a) a drive that can be steered in 3D directions and has at least one lift means for controlling a 3D movement in a transfer space, to implement a feed movement and superposition of directions of movement, highly-dynamic superimposed movements for lifting and simultaneous horizontal transport or for horizontal transport and simultaneous swiveling/tilting of the workpiece,
b) a controllable axis of the lift means that can be steered in 3D directions for realizing horizontal movements of the UAV,
c) a data network communicating with a central control/regulating device for querying and activating data of the technological or logistical criteria or production/logistic data at least for the UAV or for the workpiece or for the tool or for the press, transfer press or press line for control purposes of controlling the UAV in at least one of the following monitoring processes
   c1 a series production, one-off production or individual production,
   c2 insertion of semi-finished workpieces as special parts and a removal of the UAV from a transfer function for maintenance/repair,
   c3 an energy charge,
   c4 observation of operations in the machining of the workpieces,
   c5 position determination and centering of the workpieces.

Alternately, but also simultaneously, the UAV is designed to have at least one or one of the following features or functions for transferring the workpieces:
a) Use instead of a stationary transfer facility as was previously customary according to the state of the art,
b) a drive capable of steering the UAV in 3D directions with at least one lift means for controlling a 3D movement in a transfer space of the presses, transfer presses or press lines, to implement a feed movement and superposition of directions of movement, highly-dynamic superimposed movements for lifting and simultaneous horizontal transport or for horizontal transport and simultaneous swiveling/tilting of the workpiece,
c) a controllable axis of the lift means that can be steered in 3D directions for realizing horizontal movements of the UAV,
d) an arrangement, control, adjustment or circuit of the lift means
   d1 to generate an effective lift in a space away from the shape of the respective workpiece, and
   d2 for a positioned approach/fly-in of the workpiece for the purpose of realizing the technology-appropriate transfer, whereby the UAV can be flown with its flattest possible height and the smallest possible tilt into an area of a tool of a process station,
e) control means and attachment means for transferring the formed workpiece or the workpiece to be formed by means of attachment points on the workpiece for a process-safe motion sequence following the laws of motion inside, apart from or outside the transfer space,
f) a data network communicating with a central. control/regulating device for a transfer system for querying and activating data of the technological or logistical criteria or production/logistic data at least for the UAV or for the workpiece or for the tool or for the press, transfer press or press line to control the UAV for the transfer in at least one of the following processes
   f1 a series production, one-off production or individual production,
   f2 insertion of semi-finished workpieces as special parts and removal of the UAV from a transfer function for maintenance/repair,
   f3 an energy charge,
   f4 with attachment means,
   f5 for operations in the machining of the workpiece,
   f6 a position determination and centering of the workpiece,
   f7 a surface treatment of the workpiece (2, 2.1).

With these solution variants, the invention goes beyond the state of the art, although those previously described and previously known drones as unmanned flying objects
are already used in the industrial sector,
are capable of recognizing obstacles and avoiding them,
have facilities with redundant components and for fail-safe operation when encountering problems, for example, with artificial or machine vision,
create data in real time, allowing them to fly around and/or fly toward objects, and
are equipped with complex artificial intelligence technologies.

However, in contrast thereto, a production system according to the invention with the aforementioned combinations with the UAV operates not only with the previously known functions or features, but also with the following new and linked functions or features, such as
the drive acting in the 3D directions for controlling a 3D movement in space, and
the controllable axis, steerable in the 3D directions, of the lift means for realizing horizontal movements of the UAV, and
the adjustable lift means, with its controllable vertical axis, with its rotor blades or jet engines adjustable in the horizontal axis.

The transfer space required by the presses can thus be optimized in a perspective press plant by employing the production system according to the invention. At least in the space currently available, the UAV according to the invention, which can even be equipped, for example, with rotor blades acting on top of one another, can technologically monitor the transfer space and perform transfers despite its greater overall height.

Since—as stated at the beginning in the discussion of the prior art—until now for a product to be transferred, for example, that has not undergone a changeable or active technological process step, such as cutting or non-cutting machining, and had missing related information, the invention can minimize technologically-related and disadvantageous product liability risks. According to the invention, information on a relevant manufacturing process is made available to a UAV in order to implement technological measures required in generic, complex production systems within the scope of the process monitoring and transfer security aimed at and achieved by the invention.

For this purpose, the UAV control, monitoring and attachment means according to the invention for the process-safe, process-level-appropriate and stop-safe transfer of the workpiece has such effects and special features that—regardless of the technological machining operation—the workpiece is fed to a respective tool of the press in the correct position, such as for cutting or forming, while the production process is simultaneously monitored.

Both variants (process monitoring and transfer of the workpieces) of the production system can be carried out after consideration, evaluation and analysis of generic processes in five special logistical-technological aspects and can also be used with their complexity, for example in a press plant.

According to a first aspect of the production system according to the invention, one UAV or a group of several UAVs picks up a workpiece to be machined, transfers and accompanies it from a first process station to an n-th process station, ending with the finished component. The UAV or the group of several UAVs returns to the first process station, picks up a new workpiece and accompanies it along at least parts of the process stations while repeating the process in a circulating first flight pattern and while monitoring the respective technological process stage.

According to a second aspect of said system, one UAV or a group of several UAVs, which picks up/takes over and releases the workpiece specifically for transport between two technological operations such as forming stages, is provided to a respective process station of the press, transfer press or press line. The special technological work processes and the corresponding transfer logistics of the UAV or groups of several UAVs, such as pick-up/take-over/release, are monitored in a circulating, characterizable second flight pattern.

According to a third aspect of the system, assuming for example at least one of the two aforementioned solutions, a path measuring/positioning system corresponding to a control/regulating device (e.g. electronically) with a second data memory and computer for the requirement assigned to a function to be carried out by a UAV specifically for the technological operation is associated with each individual machine such as press, transfer press or technological press line, specifically for integrated communication with at least one of the two aforementioned solutions.

In this way, a technological function to be carried out by the UAV specifically for the technological operation can be requested and carried out by each individual press, transfer press or press line.

Accordingly, the electronic path measuring/positioning system for feeding the workpiece with the correct position and orientation also cooperates with a centering system, which can be at least partially attached, on the one hand, as a first guide means on the UAV and, on the other hand, as a second guide means on the non-moving part of the production system. Electronic and mechanical positioning can thus be combined.

Particularly advantageously, centering with the UAV according to the invention can be coupled in relation to the process as transfer device via mechanical elements. A movement in the space/transfer space takes place by employing mechanical elements with a forcibly controlled device that can be stabilized at least in 2D, with attachment means for picking up and putting down the workpiece. A joint kinematic implemented as parallel kinematics is used for this purpose. This embodiment according to the invention is significantly lighter, structurally smaller and can be implemented more cost-effectively due to the elimination of conventional mechanical transfer devices and the required driving forces and torques to be transmitted.

The centering system and the joint kinematics should or can act independently of one another. When the joint kinematics includes a light rod kinematics, the UAV drives a mechanical transfer system as a pure drive means, quasi as a motor replacement. To this end, a mechanical guidance system is provided, and the movements are positively guided.

According to a fourth aspect, an information system is integrated in a first data memory in the respective UAV, enabling the UAV to detect workpieces that were not machined in accordance with the technology, position, rolling direction, and desired quality, to record additional external information such as press data, and to execute control signals for technological measures.

According to a fifth aspect, the system according to the invention can be completed by forming in the press plant a pool of several UAVs with associated control/regulating devices. Therein, at least one UAV—regardless of its pool connection—can be activated to at least one of the following logistical or technology-relevant files or one of the signals for
a) executing the required functions that can be programmed according to a respective process station, including those process steps leading back from forming/pressing processes to cutting operations,
b) equipping with required
   i. force-fit or form-fit receptacles,
   ii. transport means such as traverses or similar,
   iii. tooling for tool changes,
c) querying to determine the type or specific features of
   iv. its drive,
   v. its communication link (free or tied),
   vi. a shape of the received workpiece, such as 2D, 3D,
   vii. a material type of the workpiece,
   viii. electro-physical properties (non-ferrous, magnetic/magnetizable, non-metallic) of the workpiece (2), such as non-ferrous, magnetic/magnetizable, non-metallic,
d) querying the availability depending on the type of
   ix. flight operations (free/tied),
   x. energy generation/supply/conversion,
   xi. creating actions on workpieces and tools, such as induction heating or fan cooling.

With this complex of solutions, the production system according to the invention effects the process monitoring and the assumption of the transfer function by employing the UAVs equipped according to the invention with their influence on the quality of the technological processes to be implemented, thereby functionally merging logistical and technological advantages. Accordingly, information regarding possible product liability risks is also available, which can be more easily calculated and reduced.

Exactly for this purpose, the respective UAV can be
charged during a return to a process station or in one of the circulating flight patterns with energy by means of accumulators, capacitors, fuel cells or similar devices supplying energy—even when not flying, like while driving on a belt;
equipped with attachment means, such as vacuum suction devices for picking up and transporting the workpieces with driven pumps, air tanks for overpressure or vacuum;
removed from a transfer function for service/maintenance;
equipped for a monitorable operational status with reporting of external data and internal status data, such as battery status, to the central control/regulating device for a monitorable operational status with reporting of data on the energy charge or on the vacuum suction devices;
equipped with optics, such as a camera, and evaluation using the first data memory with file and computer for monitoring processes relating to the machining of workpieces, parts control and transmission of control signals;
employed in dangerous process areas and as a sacrificial UAV with calculable loss;
measured externally optically, by means of ultrasound or remotely;
equipped with a self-determining or self-measuring facility for position determination by using reference points such as scales in space, such as the process area, workshop;
completed with a safety control for parking or switching off, and
particularly advantageously equipped with means for component tracking, component identification and detection of any logistical and/or technological operations.

The last-mentioned function is to be understood as referring to a barcode system, or a variant thereof, that can be read by scanners or cameras having the appropriate software and further processed electronically in accordance with the technology for identifying each workpiece. As will be described below, all relevant information for logistical and technological tracking of the workpiece is contained in and assigned to the retrievable barcode.

The invention can further advantageously be carried out with the features and/or functions described below: For the correct positioning and orientation of the workpiece, the corresponding centering system is provided with a first guide means on the UAV and a second guide means on the non-moving part of the production system.

During the work processes/operations intended for the workpieces or during the operations of the press acting on a workpiece, a UAV can be parked away from the workpiece and supplied with or charged with energy and supplied with information.

The provisioning of a number n of operational UAVs, which is controlled by the central control/regulating unit, can always be adapted to the n press strokes or can be extended by n press strokes, depending on an energy charging time. This means that a UAV is available or can be used for the first time or again for every w-th press stroke.

The respective UAV is permanently connected via a line, such as a cable and/or a hose, for the purpose of supplying external energy or is controlled free-flying, and can be recharged with energy autonomously during the technological process, such as forming.

The respective UAV can be equipped with measuring means for detecting rejects and special situations in the UAV's onboard information system using sensors for data recognition and component tracking using the barcodes listed below. The external information can be received as data for responding with the corresponding logistical or technological measures.

The respective UAV has measuring means with sensors for recognizing data of a reject and for special situations.

The UAV can also be used for “operational flying out” the scrap generated in the machining system for workpieces.

Overall, the control/regulating device contains data of safety aspects both for the individual UAV as well as for machine, workpiece and personal data that can be functionally/programmatically linked to the following operational complex:

Several UAVs, each having one workpiece, obey the technology-related commands to carry out the actions, such as movements, changes in the position of the workpiece, for example by
lifting/lowering,
transporting,
rotational movements, such as panning, tilting, turning, turning,
   wherein
these actions can be carried out with partial overlap and simultaneously, and these actions can be controlled/regulated, according to the performance data processed by the control/regulating device, using the maximum possible performance data (speed, acceleration), while implementing and observing the laws of motion,
   wherein
a learning program can be generated, which can be transferred to an external plant and can be installed or used in place of manually practiced or learned motion sequences,
   wherein
several UAVs or parts of different UAVs can be coupled with and decoupled from one another, with and without the use of common attachment means.

For this purpose, a database is set up in the control/regulating device, which includes at least one file with the following criteria:
a) data on the geographical height and location of the press plant, the position of the presses, transfer presses or press lines,
b) data on the geometry (2D, 3D) and technological operations of the work piece(s) to be picked up and reshaped, after having been cut, to the finished component,
c) data on the metallurgical or non-metallurgical properties of the material for the workpiece,
d) (machine) data of the individual process stations of the respective press, transfer press or press line,
e) data of a tool change, wherein part-specific tooling can be directly deposited on the tool,
f) data of the pool of several UAVs,
g) a barcode of the workpiece,
   which data
h) on the one hand, control the UAV and, on the other hand, can be accessed by the UAV, and
i) monitor and affect, if necessary, the logistical and technological process.

In the first data memory, the UAV includes a file with at least one criterion for the following controllable data
a) a position accompanying the workpiece or assigned to the process station/press station,
b) the type of propulsion, such as propeller, nozzle, turbine,
c) the energy supply/feed, for example integrated/stored, routable, convertible or supplied externally,
d) the mode of operation, such as free-flying or tied,
e) for transport/attachment/receiving means, such as traverse, non-positive/positive locking (suction cups, gripping pliers), multiple/single receptacle,
f) relating to separable information about the technological work processes to be carried out and those processes which have already been carried out, about the stacking/inventory situation, for quality control and any measures resulting therefrom such as the separation of parts, also by using barcodes,
g) relating to performance parameters of the UAV, including a geographical altitude (altitude of the location of the press plant), and
h) retrievable reference programs of machining processes.

The production system according to the invention is further characterized by a flight simulator for mapping and tracking the processes to be represented according to the invention. This flight simulator also serves as visual-operational process support/monitoring and enables the optimization of trajectories inside and outside the facilities or the press plant in order to increase the output of individual systems as well as the output of the entire press plant.

Especially for this purpose, the respective UAV is equipped—as stated above—
with the means for component tracking, component identification and recognition of any type of logistic or technological operations, and
with a technology-compatible, electronically processable barcode system readable by scanners or cameras with appropriate software for each workpiece.

With the invention, which can be carried out comprehensively or in a complex manner, the time lost due to removal of scrap from the tools and separation from the workpiece (formed part) and transport away can be reduced in the machining system according to the invention for the workpieces. Manipulations that have been common up to now are rationalized through the use of UAVs and “operational flying-out of scrap quasi as transfer” with the effect that simpler tools can be used and scrap removal, which was previously common due to jamming of parts, is no longer necessary. The effect has a particularly advantageous effect on the produced so-called useful scrap which is specially collected or fed directly to the next machining process.

The functions specified above, which may be linked and which determine the use of UAVs in the production system according to the invention, contribute to a mostly technological rationalization also when using the aforementioned barcode system, because the UAV
can be recharged with energy while, for example, returning to a process station by using accumulators, capacitors, fuel cells or a similar energy supply—even while not airborne and traveling on a conveyor belt;
can be equipped for transporting the blanks with driven pumps, air tanks for overpressure or vacuum for vacuum suction devices;
can be equipped with attachment means for picking up workpieces, scrap and other parts to be moved;
can be removed from a transfer function, for example, for maintenance/repair; can monitor its operational status for the purpose of reporting data to a “control center”, such as for energy charge or to the vacuum suction device;
can be equipped with conventional optics (3D camera) and evaluation in order to monitor processes of the machining of workpieces and, if necessary, send out control signals;
can be used in dangerous process areas and, if necessary, as a sacrificial UAV;
can be externally measured (i.e. outside the UAV) and thus its technical status, energy status and functionality can be checked, for example optically, by using of ultrasound or remotely controlled, specifically commensurate with the technical means employed in conventional remotely-controlled flight models or drones;
can determine or measure its position in space (process area, workshop) of the respective machine by using reference points (scales);
can be equipped for parking or switching off with a safety control in order to guarantee personal protection (occupational safety) in the space (process area, workshop);
can park and be supplied with energy or charged during the work processes/operations intended for the workpieces, such as press stroke and/or forming away from the processes/operations (e.g. a closed tool of a press or an operation acting on a workpiece);
can be controlled by a control center for provisioning a battery (park, storage) with a number n of operational UAVs, so that the number n can always be adapted to the n press strokes (or expandable by n press strokes) depending on an (energy) charging time, and a UAV is advantageously available or is only needed for every nth press stroke and is therefore always available.

According to the invention, the performance and parameters recorded by the data as well as the individual or coupled or mutually occurring actions, such as movements, are traceable and available within the system. In the system-external area of a technological work preparation, the processes together with the press and tool data can be advantageously simulated, tested, set, calculated and controlled on the aforementioned “flight simulator”.

This enables forward-looking statements regarding
removal of the workpieces,
required number of UAVs,
maintenance/repair,
loading cycle/times (of the workpieces, blanks).

Since the actions according to the invention, such as movements, must be executed according to the mathematical laws of motion (polynomials, kinematic optimization and their combinations) and must be simulated with the flight simulator, the thus conceptualized system according to the invention can significantly increase the efficiency for optimizing the removal of the workpieces, the energy consumption and the process reliability of the work processes in a now the space-optimized press plant.

On the other hand, an emergency operation can be maintained without an optimization goal when parts of the process chain, for example in the press plant, fail. The flight simulator enables possible emergency situations to be played through beforehand.

For the process monitoring and transfer system according to the invention that can be combined in, for example, the press plant, a complex program with the program steps of the processes according to the invention can be created, which also generates the aforementioned learning program, thus allowing the installation of programmed processes in further press works in place of manual execution.

Since industrial press plants as a complex production system for machining workpieces can include a different technological linking of systems, such as with
sheet metal strips to be unwound from coils,
stacking/loading devices such as blank loaders,
press types for forming machining, such as cutting, embossing, punching or three-dimensional forming (deep drawing) into pressed parts, semi-finished or finished parts,
   a process station according to the invention, for example the n-th process station in a specific press plant, can actually be a final stage, regardless of whether the machined workpiece is subject to a further logistical and/or technological process.

Therefore, the following special feature can be realized by the invention in a future industrial press plant: a UAV with several rotor blades has the attachment means such as the suction device, and several UAVs are provided for transporting a workpiece. When the UAV is idling or reversing, i.e. when no workpiece is being transported, all rotor blades of the UAV are operated or controlled by the central control unit for functionality and lift.

When several UAVs are positioned for the joint transport of the one workpiece at attachment points, individual rotor blades of different UAVs cannot provide lift, when they act due to their positioning aerodynamically against the workpiece, for example against the surfaces of a car door, and thus do not generate any lift.

In such a situation, these non-lift-providing rotor blades are switched off in a controlled manner and the rotor blades of individual UAVs which can effectively generate lift are functionally combined with one another to form a temporarily controlled group of several UAVs for transporting the workpiece.

After depositing the workpiece at one of the process stations, this group of rotor blades responsible for the lift is disbanded again in a controlled manner. The rotor blades then operate again within each participating UAV. The UAVs then leave the process area individually with rotor blades providing full lift, with one process stroke of the press performing the respective operation occurring.

The UAVs then return to the already machined workpiece or to the next workpiece in order to be able to start further transport in the transfer, and the process can be repeated.

Individual features and relationships are illustrated with reference to exemplary embodiments in an exemplary press plant and recited in the claims.

### BRIEF DESCRIPTION OF THE DRAWINGS

The invention is described with reference to examples and in the following figures.

These show in

FIG. 1 a diagram of a press plant 1 as a flow image with press, transfer press or press line 1.1, with a UAV 3 receiving a new workpiece 2 from a process station 1.2 with a first process station 1.2.1 to a process station 1.2 with an n-th process station 1.2.2 accompanying a workpiece 2 to be machined, ending with the finished formed component and returning to the first process station 1.2.1, while repeating the process, according to the first aspect of the production system according to the invention,

FIG. 2 a diagram of the process flow in the press plant 1 as a flow image with press, transfer press or press line 1.1, with a UAV 3 provided for the respective process station 1.2, which is specifically assigned to the technological operation such as the forming stage, receiving and transferring the workpiece 2, according to the second aspect of the production system according to the invention,

FIG. 3 schematic diagrams of a path measuring/positioning system associated with each press, transfer press or press line 1.1 with a second data memory and computer 1.3 for requesting a function to be carried out by a UAV 3 specifically for the technological operation according to the third aspect of the production system according to the invention,

FIG. 4 schematic diagrams of a first data memory 3.3 integrated in a UAV 3 with a file and a computer 3.3 for carrying out operational measures of the UAV 3 in accordance with the fourth aspect of the production system according to the invention,

FIG. 5.1 a schematic diagram of the system of a control/regulating device 5 for a pool 3.5 of several UAVs 3 in the press plant 1, corresponding to the fifth aspect of the production system according to the invention,

FIG. 5.2 a diagram according to FIG. 5.1, shown as a complex control and regulation system,

FIG. 6 schematic details for the transport of parts of the workpiece 2.1 relating to
an arrangement with adjustable 3.6.1, couplable 3.6.2, switchable 3.6.3 lift means 3.6 of the UAV 3,
the attachment means 3.1 of the UAV 3, and
the attachment points 2.2 on the workpiece 2 as a half-finished passenger car door 2.1, and

FIG. 7 a schematic diagram of the UAV 3 as a drive for a joint kinematics 3.8, including various mechanical elements 3.8.1 and a first guide means 3.7.

### EXAMPLES FOR CARRYING OUT THE INVENTION

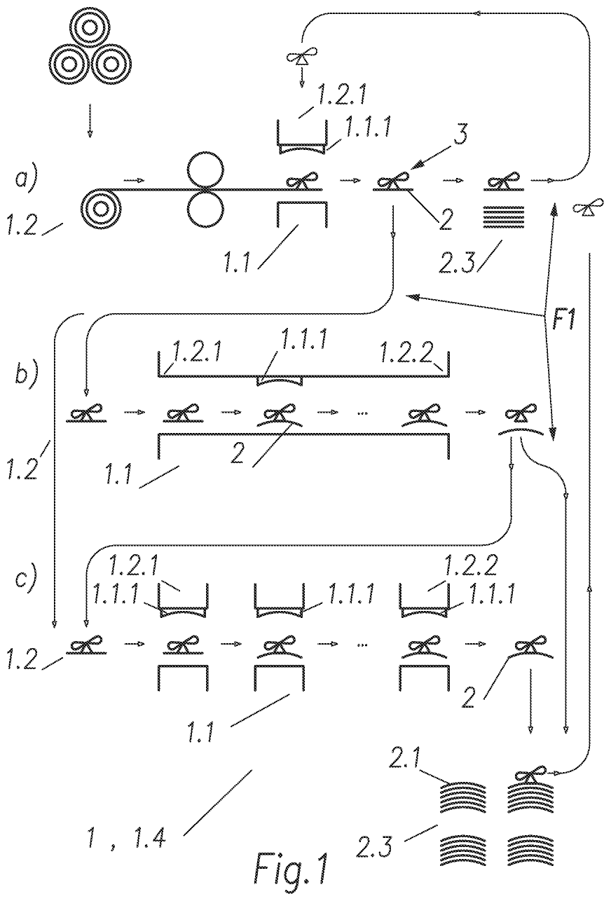

The invention will now be explained with reference to FIGS. 1 to 7, from which features and schematized, logistically and technologically linked sequences for workpieces 2, 2.1 to be machined and formed in a closed space 1.4 of an unillustrated press plant 1 with reference to a complex production system.

FIG. 1 shows in the plane of view designated with a) an unlabeled sheet-metal strip coil, an unlabeled strip feed and a cutting press 1.1 as a continuously operable process station 1.2. Thereafter, workpieces 2 are cut out by the cutting press 1.1—in this case a first process station 1.2.1—as so-called blanks for further machining such as forming.

According to the invention, at least one UAV 3 is used as a transfer device for the workpieces 2, 2.1 to further process stations 1.2, ending with the so-called semi-finished component such as a passenger car door 2.1 (FIG. 6).

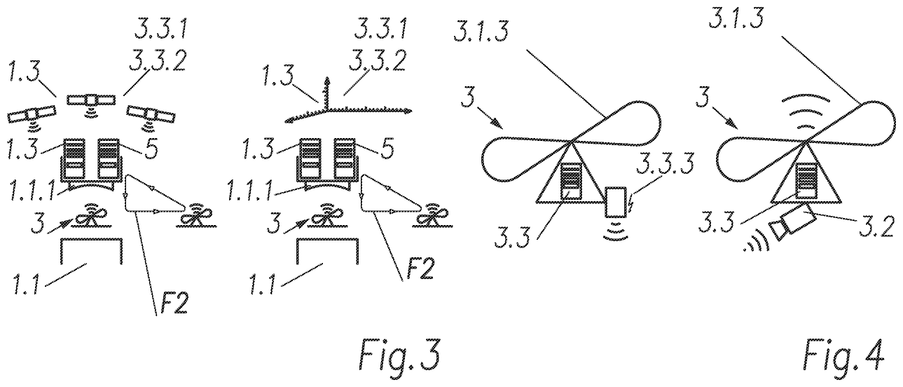

This respective UAV 3 has for the very complex technological and logistical operations for the forming machining of the workpieces 2, 2.1 the features or functions described below with reference to FIGS. 3 to 6.

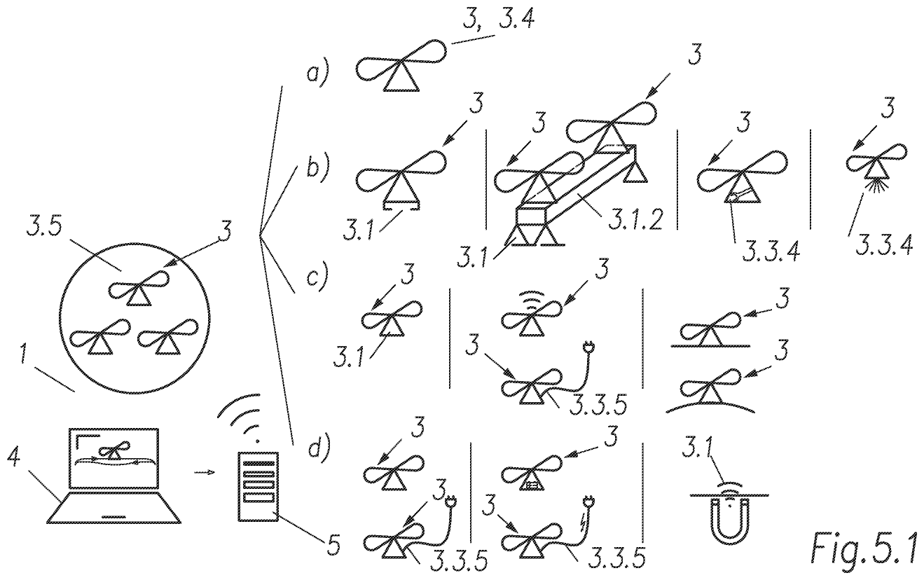

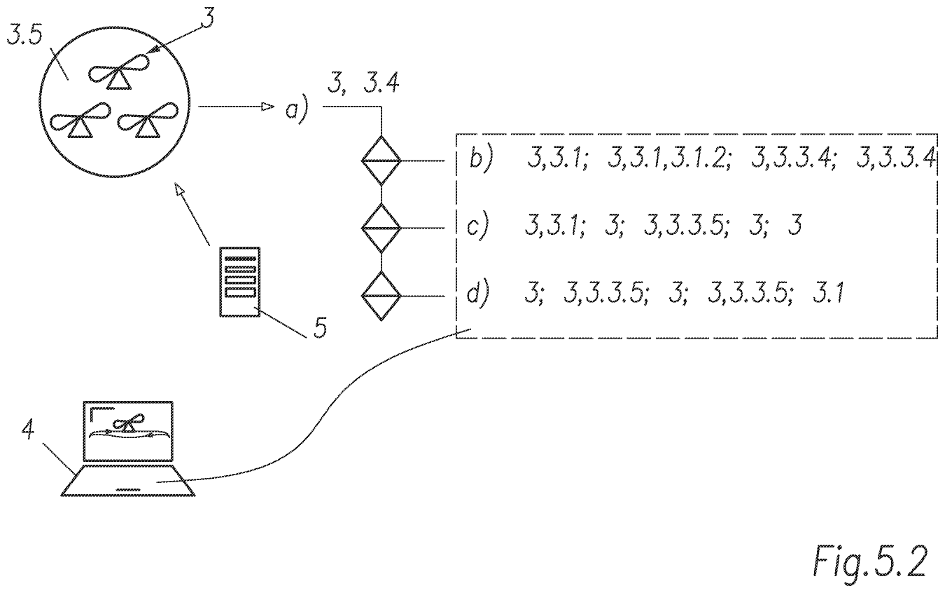

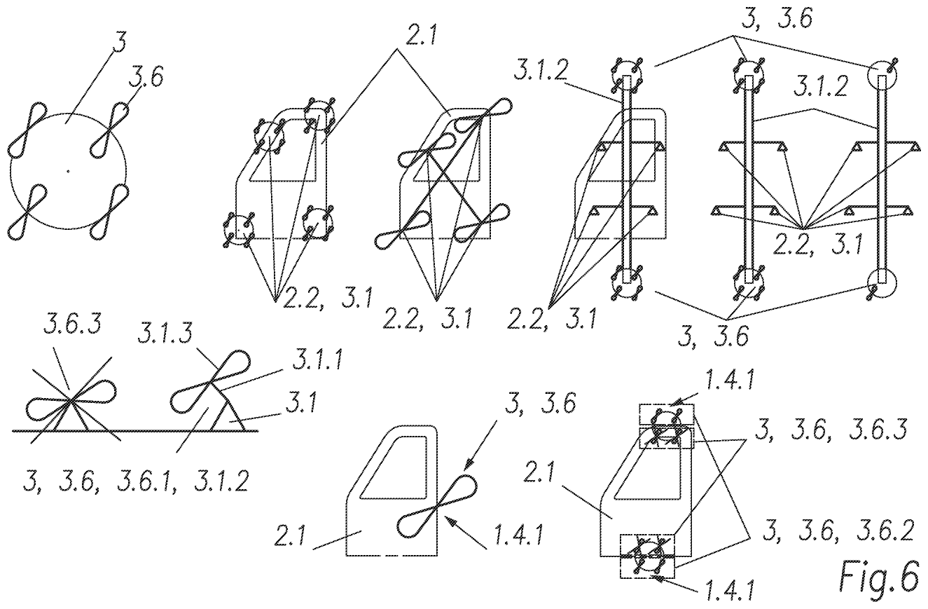

Accordingly, each UAV includes 3—similar to a helicopter/drone controllable in 3D directions—the technical means, which can be seen in more detail in FIGS. 4, 5.1, 5.2 and 6 and which enable control of a 3D movement in space 1.4, a process area or a production hall of the press plant 1. Therefore, according to FIG. 6, an arrangement, control, adjustment or switching of lift means 3.6 (propellers, jets) is provided for the UAV 3, which
ensures the generation of an effective lift commensurate with the laws of aerodynamics—also in a space 1.4.1 facing away from the shape of the respective workpiece 2, 2.1, and thus
secures, for implementing the transfer, a positioned approach/fly-in of the workpiece 2, 2.1 to a tool 1.1.1.

The UAV 3 should be flown into an area of the tool 1.1.1 of the process station 1.2 while having the least possible overall height and the smallest possible inclination. Accordingly, the overall dimensions of the employed UAV 3 can be determined in an optimized manner in accordance with the logistical and technological conditions of a press plant 1 or of the presses 1.1.

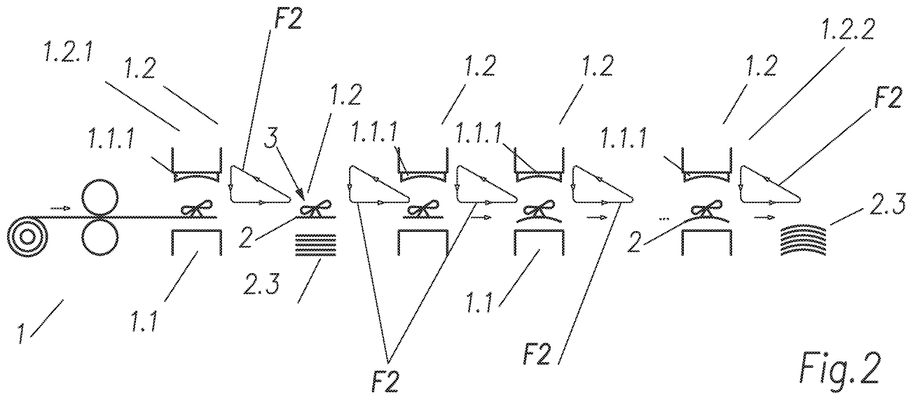

FIG. 3, FIG. 4, FIG. 5.1, FIG. 5.2 and FIG. 6 illustrate means for control and attachment means 3.1 of the transfer for each of the formed or to be formed workpieces 2, 2.1 (according to FIG. 1 and FIG. 2).

The sequence of movements in the transfer system according to the invention in the space 1.4 as a transfer space (not shown) and outside thereof is illustrated correspondingly and symbolically in FIG. 1. The movement is governed by the laws of motion and is always controlled. The attachment means 3.1 of the UAV 3 are also controlled in the same way and correspond to the attachment points 2.2 of the workpiece 2, 2.1, as can be seen in more detail in FIG. 6.

The production system with monitoring and transfer of the workpieces 2, 2.1 includes a data network for querying and activating data for the UAV 3, the workpiece 2, 2.1, the tool 1.1.1 and the respective press 1.1. This data network includes for communication a central control/regulating device 5 shown in FIG. 3, FIG. 5.1 and FIG. 5.2. In this way, all the technological and logistical criteria as well as production/logistics data can be processed and controlled, as required for series production, individual production, single production, the introduction of semi-finished special parts of the workpiece 2, 2.1, energy charging of the UAV 3, the attachment means 3.1, removal for maintenance/repair from a transfer function of the UAV 3, observation of machining operations and position determination 3.3.1 and centering of the workpiece 2, 2.1 while supporting the process in the production system.

The UAV 3 is equipped for implementing a forward feed movement and a superposition of movement directions and highly dynamic superimposed movements, such as lifting and simultaneously transporting the workpiece 2, 2.1 horizontally, or transporting the workpiece 2, 2.1 horizontally and at the same time pivoting/tilting the workpiece 2, 2.1 with a controllable rotor axis 3.1.1 shown in FIG. 6, in this example operated with rotor blades 3.1.3 (FIG. 3, FIG. 4, FIG. 6). Horizontal movements can thus be realized, with the horizontal axis of individual rotor blades 3.1.3 being adjustable. If the employed presses 1 offer sufficient transfer space in the space 1.4, the UAV 3 can be equipped with rotor blades 3.1.3 operating on top of one another, despite the greater overall height, for the purpose of transferring heavy workpieces 2, 2.1.

A first logistical-technological aspect can be inferred from the view planes a), b), c) in FIG. 1 according to this technologically and logistically linkable production system according to the invention of process monitoring and transferring the workpieces 2, 2.1. The UAV 3 accompanies the transfer the workpiece 2 to be machined as a blank received in the view plane a) from a first process station 1.2.1 to at least one further process station, such as the n-th process station 1.2.2. The UAV 3 then returns to the first process station 1.2.1, picks up a new workpiece 2 and runs at least through parts of the process stations 1.2.1, 1.2.2, and then repeats these process stations 1.2, 1.2.1, 1.2.2, as schematically shown in a first, quasi-circulating and process-monitoring flight pattern F1.

Thus, a single UAV 3 transfers the workpiece 2, 2.1, taking over from the pre-machining first process station 1.2.1, via at least one subsequent or up to the n-th process station 1.2.2 of the process stations 1.2.1, 1.2.2, and then places it in an interim storage facility 2.3. For each transfer and technological sequence to be repeated, the UAV 3 returns to the first process station 1.2.1, picks up a new workpiece 2, 2.1 and accompanies it once more through the process stations 1.2.1, 1.2.2 up to the intermediate storage facility 2.3. Each process sequence is recorded with the first flight pattern F1 of the single UAV 3 and can be monitored.

The process station 1.2 is schematically illustrated in the view plane b) as a transfer press 1.1, and in the view plane c) as a press line 1.1.

In the respective interim storage facility 2.3, cut blanks 2 (view plane a)) and machined and reshaped workpieces 2.1 are stacked for transfer to further process stations 1.2 by means of the UAV 3 or as a semi-finished component for the shell of a product.

According to this first aspect of the invention, the aforementioned logistical-technological processes or at least parts of the processes can also be taken over by a single group of several UAVs 3 instead of the aforementioned UAV 3.

Alternatively and differently, FIG. 2 shows a second logistical-technological aspect of the system according to the invention. In this case, a UAV 3 is provided for a respective process station 1.2, 1.2.1, 1.2.2 of the presses 1.1, which picks up and releases the workpiece 2, 2.1 specifically for a technological operation of the process stations 1.2, 1.2.1, 1.2.2.

This special transfer logistics of the UAV 3, corresponding to the respective technological operation, such as pick-up, transport, delivery and return, is shown in a second, quasi-circulating and process-monitoring symbolic flight pattern F2. Thus, a UAV 3, which is specifically responsible for the transfer logistics between two successive process stations 1.2, 1.2.1, 1.2.2, is provided for each process station 1.2, 1.2.1, 1.2.2, wherein the first or previous technological process step and the corresponding transfer logistics of the UAV 3 to the second or following technological process step can be monitored by the circulating second flight pattern F2.

Accordingly, this second logistical-technological aspect is distinguishable from the first logistical-technological aspect by the following characteristics:
a) one respective UAV 3 is assigned to each transfer process of the technological machining of the workpiece 2, 2.1 to be carried out from the first process station 1.2.1 to the n-th process station 1.2.2,
b) the workpiece 2, 2.1 is picked up/taken over by a first UAV 3 in a first of the process stations 1.2, 1.2.1, 1.2.2 and then delivered/transferred to the next process station 1.2.1, and is therefrom again picked up/taken over by a second UAV, such as other UAVs up to the n-th UAV 3, and handed over to one of the following process stations, up to n-th process station 1.2.2, and finally stored in the interim storage facility 2.3,
c) a new workpiece 2, 2.1, up to n-th workpiece, is transferred analogously to the sequence of steps b), and
d) each transfer and technological process of the first through the n-th UAV 3 is monitored with a dedicated second flight pattern F2.

Following the process flow of FIG. 2 from the unlabeled sheet-metal strip coil via the unlabeled strip feed to the cutting press 1.1, workpieces 2 are prefabricated as blanks in the continuously operable first process station 1.2.1, picked up by the UAV 3 that is specifically assigned to this operation and repeats this transfer logistics, and deposited at the first intermediate storage facility 2.3 for blanks 2.

Each specially assigned UAV 3 takes over the pick-up/takeover/delivery of the workpiece 2 in one of the following technological operations, such as forming stages in the respective process stations 1.2 up to the n-th process station 1.2.2.

As a result of this process according to the invention, machined and formed workpieces 2 are stacked in the second intermediate storage facility 2.3 as semi-finished components for constructing the shell of a product.

According to this second aspect of the invention, the aforementioned logistical-technological processes, at least for parts of the processes, can also be taken over by a first to n-th group of several UAVs 3, instead of the respective first to n-th UAV 3.

FIG. 3 schematically outlines a third logistical-technological aspect of the system according to the invention. Herein, an electronic path measuring/positioning system 1.3 corresponding to the central control/regulating device 5 with a second data memory and computer is assigned to each individual press, transfer press or press line 1.1, and is used equally
both in the first and/or second logistical-technological aspect,
as well as in the context of the following.

In this way, data for a function to be executed by the UAV 3 specifically for the technological operation can be communicated from each individual press, transfer press or press line 1.1 as requested, and activated.

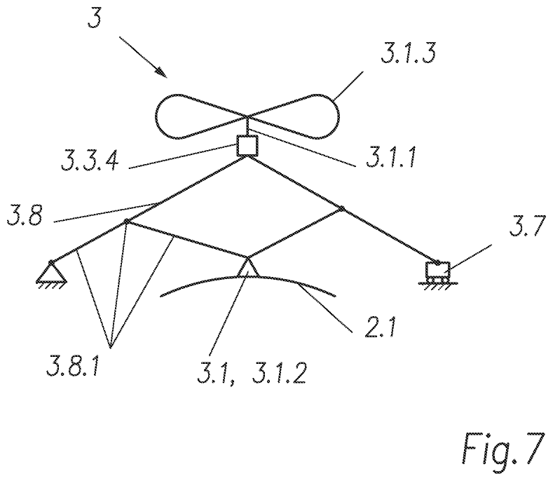

The electronic path measuring/positioning system 1.3 for feeding the workpiece 2, 2.1 with the correct position and orientation is in this example operatively connected to a centering system, which includes, on the one hand, according to FIG. 7, a first guide means 3.7 on the UAV 3 and, on the other hand, an unillustrated stationary second guide means which is integrated, for example, on the tool 1.1.1. The centering system thus acts as an advantageous and functionally synergetic combination of electronic and mechanical positioning.

FIG. 7 shows a process-related integrated mechanical transfer device that is essential to the invention and embodied on the UAV 3 operated with rotor blades 3.1.3 of the rotor axis 3.1.1. Their movement in space 1.4 is implemented with a control element 3.3.4 by way of a force-controlled, multi-dimensionally stabilizable joint kinematics 3.8, which can be coupled via mechanical elements 3.8.1, with the attachment means 3.1 and attachment elements 3.1.2 shown in FIGS. 5.1 and 5.2 for receiving and depositing the workpiece 2, 2.1 operating like a rod kinematics.

It should be emphasized that the path measuring/positioning system 1.3, the centering system and the joint kinematics 3.8 are to be regarded as being independent of one another.

With the joint kinematics 3.8, the UAV 3 is advantageously used as a pure drive means for the mechanical transfer system and drives the light-weight rod kinematics. As a result, such a transfer system is different from the transfer devices described as prior art at the beginning because it is much lighter, structurally smaller and less expensive, especially since there are no driving forces and torques to be transmitted.

In this context, according to FIG. 3, reference points (coordinates/scales) for the UAV 3 circulating, for example, along the flight pattern F2 are provided in the space 1.4 (indicated according to FIG. 1) and self-determining or self-measuring devices for position determination 3.3.1 or for parking or switching off by means of a safety control 3.3.2.

FIG. 4 shows a fourth logistical-technological aspect of the system, with an information system integrated in the respective UAV 3 in a first data memory 3.3.

This UAV 3 detects—with functional process monitoring—workpieces 2 that were not machined in accordance with the correct position, rolling direction and quality, records external information such as press data, and executes control signals for technological measures. For this purpose, measuring devices 3.3.3 such as sensors illustrated on the left side of FIG. 4, and/or optical devices 3.2 such as a camera illustrated on the right side of FIG. 4 are provided.

The measuring devices 3.3.3 with sensors are also used to recognize data from a reject and in special situations. The optical devices, such as, for example, a 3D camera 3.2, are connected for evaluation to the first data memory 3.3 with the file and computer. In this way, the processes related to the machining of workpieces 2, 2.1 can be observed and control signals can be outputted. At the same time, a UAV 3's onboard information system for data recognition as well as positioning is realized, also communicating with the electronic path measuring/positioning system 1.3 according to FIG. 3.

In addition, this onboard information system of the respective UAV 3 can communicate those particular data in the controllable first data memory 3.3 that relate to
coordinating the workpiece 2, 2.1 or a position corresponding to the process station/press station 1.2, 1.2.1, 1.2.2,
the type of propulsion or lift means 3.6, such as propeller, jets, turbine,
the type of energy supply/feed, such as integrated/stored, conveyable, changeable,
the operating mode, such as free-flying or tied down,
transport/attachment means 3.1, such as traverse, non-positive/positive (suction cups, gripping pliers), multiple/simple receptacle,
separable information about technological operations to be carried out and previously carried out, stacking/storage situation, quality control and any measures resulting therefrom, separation of parts, also by using barcodes,
recording, machining and outputting performance data of the UAV 3, including data relating to a geographical altitude, such as the altitude of the press plant 1, and retrievable reference programs of machining processes.

Lastly, FIGS. 5.1 and 5.2 sketch in form of individual schematic diagrams, a technologically and logistically significant fifth aspect of the production system according to the invention.

According to FIG. 5.1, the unillustrated press plant 1 includes a pool 3.5 of several UAVs 3, the control/regulating device 5 that controls, i.e. functionally monitors, this pool 3.5, and a flight simulator 4.

With the control/regulating device 5, the respective UAV 3 is controlled in the interrogation mode with the following signals for
carrying out the required functions, programmed according to a respective process station 1.2, 1.2.1, 1.2.2, including forming/pressing processes and return process steps, for example to cutting processes;
equipping with the necessary attachment means 3.1 and tools for maintenance by means of
   force-fit or form-fit mountings,
   transport means, such as traverses and the like,
   tooling for changing tools 1.1.1,
   performing actions on workpieces 2, 2.1 and tools 1.1.1, such as heating by induction, cooling with a fan;
determining the type or specifics of its drive, its communication link (free or tied down), a shape (2D, 3D) of the received workpiece 2, 2.1;
making provisions according to the type of flight operation (free/tied down), energy generation/supply/conversion, other actions.

With the production system that is logistically and technologically linked in this way and operates according to the invention as a process monitoring and transfer system, previously unprofitable secondary processes can be integrated so efficiently that from the pool 3.5, for example by using only one UAV 3, the scrap generated in the machining system for workpieces 2, 2.1 can be controllably, “operatively flown out”.

Furthermore, a UAV 3 can be powered by batteries, capacitors, fuel cells or similar energy supply or charged—also when not airborne, like driving on a belt—or diverted from a function (e.g. flight pattern F2 in FIG. 2) for necessary maintenance/repair, and a UAV 3 available from the pool 3.5 can be inserted in a process-safe manner for a controlled return to a process station 1.2, 1.2.1, 1.2.2, for example according to the flight pattern F1 in FIG. 1.

The UAV 3 is equipped
for a monitorable operational status with reporting of external data and onboard status data such as battery status for energy charging or for attachment means such as a vacuum suction device to the central control/regulating device 5, and
with optics such as camera 3.2 for evaluation by means of the first data memory with file and computer 3.3 for observing processes of the machining of workpieces 2, 2.1, parts control and transmission of control signals.

In principle, every controlled UAV 3 can be measured externally optically, by ultrasound or remotely.

In addition, the respective UAV 3 is equipped with means for component tracking, identification and recognition of any logistical and/or technological operations, for which purpose a barcode system (or similar system) that can be read by scanners or cameras with appropriate software and electronically machined is provided on each workpiece 2, 2.1.

The production system according to the invention thus ensures that during the ongoing work processes/operations on the workpieces 2, 2.1 or the operations of a press 1.1 on a workpiece 2, 2.1, a UAV 3 that is parked away from the press 1.1 can be supplied with energy or charged and reinserted.

Overall, the production system, with the provision of a number n of operational UAVs 3 that are controlled by the central control/regulating device 5, synergistically supports the actual press operation in such a way that this number can always be adapted to the n press strokes or can be extended by n press strokes depending on the (energy) charging time, so that the UAV 3 is technologically available or reusable for every o-th press stroke.

FIG. 5.1 shows symbolically in the functional connection with the control/regulating device 5, the pool 3.5 and the flight simulator 4 that the respective UAV 3
in view a), can be used as a sacrificial UAV 3.4 which may be discarded, if necessary, in dangerous process areas as a calculated loss object;
in view b), can be equipped for attachment means 3.1 such as vacuum suction cups (with unillustrated) drivable pumps, air tanks for overpressure or vacuum, for transporting workpieces 2, 2.1 or for maintenance tools;
in views c) and d), can be used as a UAV 3 that is permanently connected via a line, such as cable and/or hose 3.3.5, for the purpose of external energy supply or is equipped with e-magnetic attachment means 3.1 or rechargeable with energy in flight.

FIG. 5.2 illustrates the invention as a complex control system integrated in the technological and logistical processes of the press plant 1 according to views a) to d), specifically in cooperation with the analog functions of the UAV 3 previously captured in FIG. 5.1.

Accordingly, this control and regulation system includes with
the block according to view a) the use of the sacrificial UAV 3.4 in dangerous process areas as a calculated loss object,
the block according to view b), the use of the attachment means 3.1 with attachment elements 3.1.2 and control of the rotor axis 3.1.1, the rotor blades 3.1.2 by means of control element 3.3.4,
the blocks according to views c) and d), the control of a UAV 3 that is connected via a line, such as cable and/or hose 3.3.5, for the purpose of external energy supply, or that is equipped with e-magnetic attachment means 3.1 or chargeable with energy in free flight, wherein the UAV 3 is available from the pool 3.5 and is monitorable/trackable using flight simulator 4.

In general, the control/regulating device 5 links and is able to communicate functional/program-related data relating to safety aspects for the individual UAV 3 as well as machine, workpiece and personal data for executing the following functions essential to the invention:
several UAV 3, each with a workpiece 2, 2.1, follow the technology-related controlled commands to carry out the actions (3D movements, changes in position) of the workpiece 2, 2.1, such as lifting/lowering (z-axis), transporting (y-axis), swiveling, tilting, rotating, turning, including actions such as inductive heating of workpiece 2, 2.1 or cooling of workpiece 2, 2.1 by means of a fan.
control/regulation of the partially superimposed or simultaneously executed actions with the performance data processed by the control/regulating device 5 and the maximum possible performance data in the press plant 1,
additional generation of a learning program, which can be used for later processes and is repeatable, transferable and installable in an external plant or used in lieu of manually practiced or learned movement sequences.

The database set up for this in the control/regulating device 5 also includes a file of the following data:
data of the geographical altitude and location of the press plant 1, the position of the presses, transfer presses or press lines 1.1 in the space 1.4,
data of the geometry (2D/3D shape) and technological operations of the workpiece 2 to be picked up and formed after being cut up, ending with the finished component such as passenger car door 2.1, (machine) data of the individual process stations 1.2, 1.2.1, 1.2.2 of the respective press, transfer press or press line 1.1, data of a change of the tool 1.1.1, and data of the pool 3.5 with several UAV 3 and barcode or similar data.

These data are used, on the one hand, to control the UAV 3 and, on the other hand, can be called up by the UAV 3.

FIG. 6 shows details according to the invention of the parts transport of the workpiece 2 in form of a car door 2.1 typical for a press 1.

In this case, the workpiece 2.1, which is machined and formed following the cutting and forming operations and which is to be transferred by means of the process-monitoring UAV 3, is manufactured in accordance with the planned logistical and technological processes, finally be provided as a passenger car door 2.1 for a passenger car shell according to the production system according to the invention, in particular with the complexity of the combinable solution variants, including a surface treatment of the workpiece 2, 2.1, and the first or second and third to fifth logistical-technological aspects described above.

According to the features inferred from FIG. 6, the UAV 3 can also be operated in the embodiments with
a lift means 3.6 (image, center left), or
several lift means 3.6 (image, top left) and in this case by using propellers such as rotor blades 3.1.3.

Depending on the execution and the required 2D or 3D movement sequences, the respective UAVs 3 are equipped with attachment means 3.1 (FIG. 5.1), which are attached at exposed, balanced and predeterminable attachment points 2.2 of the passenger car door 2.1 and transfer/transport the same up to the second intermediate storage facility 2.3 (FIG. 1, FIG. 2).

According to FIG. 6, in the upper view plane with the (unlabeled) first attachment position, starting on the left, up to the (unlabeled) fifth attachment position, the following examples of attachment types of the UAV 3 for transferring, such as picking up and putting down the car door 2.1, are possible for this purpose:
four UAVs 3, each equipped with several lift means 3.6, are attached at predetermined, balanced attachment points 2.2,
four UAVs 3, each equipped with a lift means 3.6, are attached at the designated receiving points 2.2, wherein the UAVs 3—as indicated in the form of a cross—are connected mechanically (traverse) or via electronical communication,
two UAVs 3 each with several lift means 3.6 at the end of an indicated traverse with 2 cross members are attached at four attachment points 2.2 (third to fifth attachment positions).

FIG. 6 also shows the UAVs 3 having attachment elements 3.1.2 in the center of the image
on the left-hand side with a disconnectable lift means 3.6.3, and
on the right-hand side, the lift means 3.6.1 adjustable with the rotor axis 3.1.1.

On left-hand side of the lower image plane, a point-shaped attachment of the UAV 3 with the lift means 3.6 on the car door 2.1 for the lift-preserving transfer in a space 1.4.1 away from the shape of the passenger car door 2.1 is illustrated and easily visible.

Likewise, as illustrated and easily visible on the right-hand side of the lower image plane, the passenger car door 2.1 or a differently formed or machined workpiece 2, 2.1, depending on the geometric design and the technological machining steps, can be transferred in the correct position commensurate with the controlled technological and logistical 2D or 3D movement sequences according to FIG. 5.2 in the space 1.4 of the press plant 1 by the control and regulating device 5 and adjustable 3.6.1, couplable 3.6.2 or switchable 3.6.3 lift means 3.6 of the UAV 3.

The use of any UAV 3 in the space, process area, working plant 1.4 of the press plant 1, including the lifting positions at the lifting points 2.2 of the workpiece 2, 2.1, are to be planned and implemented in accordance with the logistics and design so that the lift means 3.6, such as propeller, jet maintain lift in accordance with the aerodynamic lift laws, but also can be switched off. This is shown symbolically, for example, as a detail in FIG. 6, center image, and lower left and right images.

In an embodiment of the second logistical aspect of the system according to the invention, which is shown in FIG. 2, according to which one UAV (or a group of several UAVs) 3 is provided to a respective process station 1.2, 1.2.1, 1.2.2 of the presses 1.1, which especially for a technological operation of the process stations 1.2, 1.2.1, 1.2.2 picks up and releases the workpiece 2, 2.1, the following should be emphasized in more detail.

This special transfer logistics of the UAV 3, corresponding to the respective technological operation, such as pick-up, transport, delivery and return, is shown in a second, quasi-circulating and process-monitoring symbolic flight pattern F2.

Assuming that a UAV 3 with several rotor blades 3.1.3 has attachment means 3.1 such as suction cups, several UAV 3 are provided for transporting a workpiece 2, 2.1. When the UAV 3 is idling or returning, i.e. when no workpiece 2, 2.1 is being transported, all rotor blades 3.1.3 of the UAV 3 are functional and provide lift when monitored and operated and/or controlled by the central control/regulating device 5.

When several UAVs 3 are positioned at attachment points 2.2 for the joint transport of one workpiece 2, 2.1, individual rotor blades 3.1.3 of different UAV 3 may not provide effective lift, when they act, due to their positioning, aerodynamically against workpiece 2, 2.1, for example against surfaces of the passenger car door 2.1, and thus do not generate any lift. In this situation, these rotor blades 3.1.3 that do not contribute to the lift are according to the invention switched off in a controlled manner, and rotor blades 3.1.3 of different UAVs 3 positioned so as to provide effective lift are functionally combined with one another as a temporarily controlled group of several UAVs 3 for transporting the workpiece 2, 2.

After the workpiece 2, 2.1 has been deposited at a next process station 1.2, 1.2.1, 1.2.2, this group of rotor blades 3.1.3 effecting the lift is disbanded again in a controlled manner. The rotor blades 3.1.3 thus cooperate again within the respective UAVs 3, and the UAVs 3 each leave the process area in the space 1.4 individually, with their rotor blades 3.1.3 providing full effective lift.

The press 1.1 executing the work process then performs a stroke. The UAV 3 then return to the already formed or to the next workpiece 2, 2.1 to be able to take up the ongoing transport in the transfer, with this process being repeated.

With regard to the future implementation of the production system, the following logistically and technologically improved linkage of features of the invention is essential:
The correct position- and orientation-dependent feed and removal of the workpiece 2, 2.1 in the process stations 1.2, 1.2.1, 1.2.2 with the respective cutting and forming tools 1.1.1 that carry out the technological operations and have each one upper tool and one lower tool, from which the workpiece 2, 2.1 must be removed after the work step.
The path measuring/positioning system 1.3 communicating with each single press, transfer press or press line 1.1 and with the central control/regulating device 5 having the second data storage device and computer for requirements of the function to be carried out by the UAV 3 specifically for the technological operation.
The centering system integrated with path measuring/positioning system 1.3 for feeding the workpiece 2, 2.1 with the correct position and orientation, which ensures a smooth insertion of the workpiece 2, 2.1 at an exact position, on the one hand, via the first guide means 3.7 and, on the other hand, via the second guide means which is stationary with respect to the tool 1.1.1.

### Commercial Applicability

The process-monitoring production system disclosed according to the invention for workpieces to be machined with their transfer by means of inexpensive, technology-oriented UAV (Unmanned Aerial Vehicle) offers a significant potential of technological improvements, especially in press plants to be planned in the future, due to the elimination of installation space and of expensive transfer facilities, compared to the present state of the art, where unmanned aerial vehicles/objects have a high level of equipment in terms of mechanical and electronic means as well as integrated data machining, but have only taken over logistical functions in processes in production systems.

### LIST OF REFERENCE SYMBOLS

1 press plant
1.1 press, cutting press, transfer press, press line
1.1.1 tool with upper and lower part, second guide means
1.2 process station,
1.2.1 first process station
1.2.2 n-th process station
1.3 path measuring/positioning system, second data memory and computer,
1.4 space, process area, workshop
1.4.1 space remote from the shape of a respective workpiece 2, 2.1
2 workpiece, blank, component
2.1 workpiece to be machined, to be shaped, shaped, passenger car door
2.2 attachment point
2.3 interim storage facility
3 UAV
3.1 attachment means, vacuum suction cups, e-magnetic
3.1.1 axis, rotor axis
3.1.2 attachment element
3.1.3 rotor blade
3.2 optical means, camera.
3.3 first data memory with file and computer
3.3.1 device for determining position
3.3.2 safety control
3.3.3 measuring means, sensor
3.3.4 control element
3.3.5 line, cable, hose
3.4 sacrificial UAV
3.5 pool, battery, storage facility
3.6 lift means, propeller, jet
3.6.1 adjustable lift means,
3.6.2 lift means, can be operated coupled, providing effective lift
3.6.3 lift means, can be switched off, not providing effective lift
3.7 first guide means
3.8 joint kinematics
3.8.1 mechanical element
4 flight simulator
control/regulating device
F1 first flight pattern
F2 second flight pattern

1-43. (canceled)

44. A production system for machining workpieces (2, 2.1) utilizing a press unit (1.1), with a transfer that encompasses picking up and forwarding the workpieces (2, 2.1) for machining, from process station (1.2) to process station (1.2) in a space (1.4),
wherein at least one unmanned aerial vehicle (UAV) (3) is monitoring the production process of one of the workpiece (2, 2.1) or the process support that includes transfer of the at least one workpieces (2, 2.1),
wherein the UAV (3) comprises at least one lift (3.6), which when receiving a workpiece (2, 2.1), provides
a first lift (3.6.3) that does not effect lift, which is designed to be switched off, and
at least a second lift 3.6.2) that effects lift, which is used for the monitoring or a process support of the UAV (3) in the transfer of at least one of the workpieces (2, 2.1) and
wherein the at least one lift (3.6) of the UAV (3) is one of a propeller and a jet drive.

45. The production system according to claim 44, wherein the lift (3.6) can be controlled for adjustment away from its vertical axis.

46. The production system according to claim 45, wherein the UAV (3) is equipped with an attachment (3.1) for transporting the workpieces (2, 2.1).

47. The production system according to claim 46, wherein the UAV (3) comprises for the production sequence of the workpieces (2, 2.1) to be monitored at least one or one of the following features or functions:
a) a drive that can be controlled in a 3D direction with at least one lift (3.6, 3.6.1, 3.6.2, 3.6.3) for controlling a one-dimensional or multi-dimensional movement in the space (1.4) for implementing a lifting or advancing movement and superposition of directions of movement, dynamic superimposed movements such as lifting and simultaneous horizontal transport or horizontal transport and simultaneous swiveling/tilting of the workpiece (2, 2.1),
b) a data network communicating with a central control/regulating device (5) for querying and activating data of the technological or logistical criteria or manufacturing/logistic data at least for the UAV (3) or for one of the workpiece (2, 2.1), a tool (1.1.1), one of the presses (1.1) for controlling the UAV (3) in at least one of the following monitoring processes
b1 series production, one-off production or individual production,
b2 transfer of semi-finished workpieces (2, 2.1) as special parts and removal of the UAV (3) from a transfer function for maintenance/servicing,
b3 energy charging,
b4 observing of operations in the machining of the workpieces (2, 2.1),
b5 position determination (3.3.1) and centering of the workpieces (2, 2.1).

48. The production system according to claim 47, wherein the UAV (3) is configured for the transfer of the workpieces (2, 2.1) further including at least:
a) use instead of a stationary transfer facility,
b) a drive configured to control the UAV (3) in the 3D direction with at least one lift (3.6, 3.6.1, 3.6.2, 3.6.3) for controlling a one- or multi-dimensional movement in the space (1.4) to implement a lifting or advance movement and superposition of directions of movement, highly dynamic superimposed movements,
c) an arrangement, control, adjustment or switching of at least one of the lifts (3.6, 3.6.1, 3.6.2, 3.6.3)
c1 for generating an effective lift in a space (1.4.1) away from the shape of the respective workpiece (2, 2.1), and
c2 for the positioned approach/fly-in of the workpiece (2, 2.1) for the purpose of realizing the technology-appropriate transfer, wherein the UAV (3) can be flown with the flattest possible height and with the smallest possible inclination into an area of a tool (1.1.1) of a process station,
d) controls and attachment (3.1) for transferring the workpiece to be formed or already formed by attachment points (2.2) on the workpiece (2, 2.1) for a process-safe movement sequence in the space (1.4) and away from or outside the space (1.4), while obeying the laws of movement,
e) a data group communicating with a central control/regulating device (5) for the transfer to query and activate data of the technological or logistical criteria or production/logistic data at least for the UAV (3) or for the workpiece (2, 2.1) or for the tool (1.1.1) or for the press, transfer press or press line (1.1) for controlling the UAV (3) for the transfer in at least one of the following transfer sequences
e1 series production, one-off production or individual production,
e2 transfer of semi-finished workpieces as special parts,
e3 removal of the UAV from a transfer function for maintenance/repair,
e4 energy charging,
e5 with the attachment (3.1),
e6 for operations in machining the workpiece (2, 2.1),
e7 determining position and centering the workpiece (2, 2.1),
e8 surface treatment of the workpiece (2, 2.1).

49. The production system according to claim 48, wherein the UAV (3)
a) takes over the workpiece (2, 2.1) from a prefabricating or first process station (1.2.1), transfers the workpiece (2, 2.1) via at least one subsequent or up to an n-th process station (1.2.2) of the process stations (1.2.1, 1.2.2) and deposits it, and
b) returns to the first process station (1.2.1) for each repeatable transfer and technological sequence, picks up a new workpiece (2, 2.1) and accompanies the process in the process stations (1.2.1, 1.2.2) and deposits the workpiece (2, 2.1),
wherein steps a) and b) are included in a first flight pattern (F1) of the UAV (3) or the group of UAVs (3) and can be monitored.

50. The production system according to claim 49, wherein
a) for each transfer process, a first UAV (3) or a first group of UAVs (3) is assigned from the first process station (1.2.1) to the next process station (1.2.2) to the machining of the workpiece (2, 2.1) to be performed,
b) the workpiece (2, 2.1) is picked up/taken over in a first of the process stations (1.2, 1.2.1) from the first UAV or the first group of UAVs (3) and then delivered/handed over to the next process station (1.2), where the workpiece (2, 2.1) is again picked up/taken over by at least one UAV or a group of further to n-th UAVs (3) and delivered/handed over to one of the following up to the n-th process station (1.2.2),
c) a new up to n-th workpiece (2, 2.1) is transferred analogous to the sequence of steps b), and
d) each transfer process of the first UAV or the first to n-th group of UAVs (3) includes a second flight pattern (F2) and can be monitored,
e) wherein each UAV or each group of UAVs (3) picks up/takes over and releases the workpiece (2, 2.1) specifically for the transport between two technological operations, and wherein the special technological operations and the corresponding transfer logistics of the UAV or the group of UAVs (3) are monitored in each circulating second flight pattern (F2),
wherein the group of UAVs (3) is available for at least some of the process stations (1.2.1, 1.2.2).

51. The production system according to claim 50, wherein the workpiece (2, 2.1) is deposited in an intermediate storage facility (2.3).

52. The production system according to claim 50, wherein in the transfer from process station (1.2) to process station (1.2) in the space (1.4), one of the process stations (1.2, 1.2.1, 1.2.2) is a final stage of the machining or the start of further machining or processing of the workpiece (2, 2.1).

53. The production system according to claim 50, wherein a path measuring/positioning system (1.3) corresponding to the control/regulating device (5) and having a second data memory and computer is assigned to each (1.1) for requesting a function to be carried out by a UAV (3) specifically for the technological operation.

54. The production system according to claim 50, wherein an information system is integrated in the first data memory (3.3) in the respective UAV (3), enabling the UAV (3) to
a) identify workpieces (2, 2.1) that were not machined according to position, rolling direction or quality,
b) record data from presses (1.1), and
c) execute or derive control signals for technological measures.

55. The production system according to claim 50, wherein a multicity (3.5) of UAVs (3) with the control/regulating device (5) controlling the multiplicity of pool (3.5) is formed in the press (1), with which at least one UAV (3) can be
a) programmed with at least one of the signals for executing the functions corresponding to a respective process station (1.2, 1.2.1, 1.2.2), including forming/pressing processes and process stages leading back to cutting processes,
b) activated for providing
i. maintenance tools,
ii. a non-positive or positive attachment (3.1)
iii. transport unit, such as traverses,
iv. tooling for tool changes
v. creating actions for workpieces (2, 2.1) and tools (1.1.1),
vi. heating by induction, cooling with a fan,
c) queried for determining the type or specifics
i. of its drive,
ii. of the drive's communication link,
iii. shape of the picked-up workpiece (2, 2.1) (2D, 3D),
iv. a material type of the workpiece (2, 2.1),
v. electro-physical properties, including one of non-ferrous, magnetic/magnetizable, non-metallic property of the workpiece (2, 2.1),
d) availability can be queried depending on
i. flight operations (free/tied),
ii. energy generation/supply/conversion,
iii. actions to be performed on workpieces (2, 2.1) and tools (1.1.1).

56. The production system according to claim 55, wherein the UAV (3) incudes optical equipment (3.2) and 3D camera and an evaluation unit with a controller (3.3) with a first data memory with a file and a computer for observing processes of the machining of the workpieces (2, 2.1), parts control and transmission of signals.

57. The production system according to claim 56, wherein data from spatial coordinates of the UAV (3) are captured externally by one of an optical device, a ultrasound. an electronically, and the movement of the UAV (3) is performed in a controlled or in regulated manner by specifying said data.

58. The production system according to claim 57, wherein the UAV (3) comprises a self-determining or self-measuring device for determining a position (3.3.1) by using reference points (coordinates/scales) in the space (1.4).

59. The production system according to claim 58, wherein the UAV (3) is equipped with a tracking device, identifying the workpiece (2, 2.1) and for recognizing logistical/technological operations.

60. The production system according to claim 59, wherein provisioning of a number n of operational UAVs (3) that are controlled by the central control/regulating device (5), and is adapted to a number of press strokes depending on the energy consumption and the energy charging time of the UAV (3).

61. The production system according to claim 57, wherein both data relating to safety aspects for the individual UAV (3) and data relating to a machine, workpiece and personal date can be functionally/program-linked in the control/regulating device (5) in such a way that
a) several UAVs (3), each having a workpiece (2, 2.1), follow the technology-dependent commands for carrying out the actions (3D movements, changes in position) of the workpiece (2, 2.1) for lifting/lowering, transporting, for rotary movements such as swiveling, tilting, rotating, or turning, including the actions of heating the workpiece (2) by induction, cooling the workpiece (2, 2.1) with a fan, or
b) these actions performed partially superimposed, simultaneously, and can be controlled/regulated according to the performance data of these actions machined by the control/regulating device (5) according to the maximum possible performance data, or
c) a learning program can be generated which can be transferred and installed in an external (press) plant (1), or which can be used in place of manually practiced or learned movement sequences, or
d) several UAVs (3) or parts of different UAVs (3) can be coupled with and decoupled from one another, with or without using of common lifting elements (3.1).

62. The production system according to claim 53, wherein a database is set up in the control/regulating device (5) which has a file comprising at least one type of the following data:
a) data on the geographical altitude and location of the press plant (1), the position of the presses, transfer presses or press lines (1.1),
b) data regarding the geometry (2D, 3D) and technological operations of the workpiece to be picked up and reshaped after cutting (2, 2.1) up to the finished component,
c) data on the metallurgical or non-metallurgical properties of the material of the workpiece (2, 2.1),
d) data for identifying the workpiece (2, 2.1) with for example barcodes,
wherein the data are implemented as
e) as (machine) data of the individual process stations (1.2, 1.2.1, 1.2.2) of the respective press, transfer press or press line (1.1),
f) as data of a tool change, wherein a part-specific tooling can be placed directly on the tool (1.1.1),
g) as data of the pool (3.5) with several UAVs (3),
and, on the one hand, control the UAV (3) and, on the other hand, can be called up by the UAV (3) and can monitor or act on the logistical and technological process.

63. The production system according to claim 62 wherein the UAV (3) can be equipped with measuring means for the detection of rejects and special situations in the onboard UAV (3) information system with sensors for data recognition and component tracking.

64. The production system according to claim 44, wherein the UAV (3) in the controllable first data memory (3.3) comprises a file with at least one of the following criteria:
a) a position accompanying the workpiece (2) or a position assigned to the process station/press station (1.2, 1.2.1, 1.2.2),
b) the type of lift means (3.6) implemented as a propeller, jet or turbine,
c) the energy supply/supply being integrated/stored, suppliable, convertible,
d) the mode of operation as free-flying or tied up,
e) the attachment means (3.1) and attachment points (2.2) for the transfer,
f) separable information about respective technological operations carried out or to be carried out, with respect to the stacking/storage situation, to quality control and the resulting measures such as separation of parts,
g) performance data of the UAV (3), including its geographical altitude and location of the press plant (1),
h) callable reference programs of machining processes.

65. The production system according to claim 44, wherein an identification system of each workpiece (2, 2.1) that can be read by scanners or cameras with appropriate software and further machined electronically commensurate with the technology.
